(19) United States
(12) Patent Application Publication
(10) Pub. No.: US 2006/0271255 A1
(43) Pub. Date: Nov. 30, 2006

(54) System and method for vehicle diagnostics and prognostics

(75) Inventors: David Stott, Lancashire (GB); Ian Legate, Manchester (GB)

Correspondence Address: LAW OFFICE OF BRUCE D. RUBENSTEIN, 405 WALTHAM STREET, #404, LEXINGTON, MA, 02421, US

(73) Assignee: Teradyne, Inc., Boston, MA (US)

(21) Appl. No.: 11/320,006

(22) Filed: Dec. 28, 2005

Related U.S. Application Data
(60) Provisional application No. 60/640,823, filed on Dec. 30, 2004.

(51) Int. Cl. G01M 17/00

(52) U.S. Cl. 701/29; 701/33

(57) ABSTRACT

A vehicle diagnostic and prognostic system and method is disclosed. The preferred system operates from a centralized processor-based data network system and also includes a vehicle interface architecture subsystem, a vehicle configuration information subsystem, an applications engine, and a presentation subsystem. More specifically, the vehicle interface architecture subsystem is adapted for retrieving operational data and identification data from a vehicle and the vehicle configuration information subsystem is adapted for providing vehicle configuration data, vehicle variant data and/or driving style related data to the diagnostic and prognostic system. Both of these subsystems are also coupled to the applications engine that is adapted for analysing the various data, identifying trends and making an overall diagnosis or prognosis. The vehicle diagnostic and prognostic information presentation subsystem is also coupled to the applications engine and adapted for graphical presentation of information to the repair technician or other interested parties.

### CROSS REFERENCE TO RELATED APPLICATIONS

This application claims the benefit of U.S. provisional patent application Ser. No. 60/640,823 filed Dec. 28, 2004; the disclosure of which is incorporated by reference herein.

### STATEMENT REGARDING FEDERALLY SPONSORED RESEARCH

(None)

### SEQUENCE LISTING OR COMPUTER PROGRAM

(None)

### BACKGROUND

The present invention relates to a system and method for vehicle diagnostics and prognostics, and more particularly, to a system and method of vehicle diagnostics and prognostics that utilizes vehicle configuration and variant data from the manufacturer of the vehicle together with vehicle operational data in a flexible, real-time environment.

In a broad sense, one may think of vehicle service and maintenance as consisting of either fixed schedule vehicle service or unplanned vehicle failure resolution. Traditionally, time and/or mileage are the predominant factors used for fixed scheduled maintenance intervals and the vehicle manufacturer often bases such service intervals on heuristics data collected. Fixed service schedules usually only check items planned for that service period and often force replacement of components irrespective of the condition of the component. For unplanned vehicle failure resolution, no data is captured before a failure occurs that could be helpful to outline the environment that contributed to the failure. Accordingly, the repair technician is often diagnosing vehicle failures with only subset of information retrieved from the owner of the vehicle or the vehicle itself after the failure occurred. In addition, for both fixed schedule service as well as unplanned vehicle failure, the vehicle manufacturer does not get feedback from actual driving habits and styles associated with real component failures.

More recently, OBD systems and remote diagnostic systems have been developed in an effort to improve vehicle service and maintenance experiences. On-Board Diagnostic (OBD) and remote diagnostic systems are claimed be services to reduce warranty costs, product development costs and marketing costs for the vehicle manufacturer and a means to offer better after-sale support to their customers. OBD systems expand the traditional diagnostic systems through the collection of vehicle operational data to be used in conjunction with information retrieved from the owner or vehicle after the failure occurred. In addition, many OBD systems and remote diagnostic systems typically require use of customized equipment. In the case of remote diagnostic systems high-end client devices as well as a continuous, high-bandwidth connection to the client are also required.

Neither OBD or remote diagnostics make any effort to expand the sources of data that could be useful to vehicle diagnostics and prognostics. In addition, OBD and remote diagnostics define a relatively static environment that requires the use of dedicated equipment, prescribed subset of data and pre-programmed historic diagnostic and prognostic software applications. As such, most OBD and remote diagnostic systems have little or no flexibility to change or adapt as new vehicles or vehicle configurations are introduced or new maintenance, diagnostic or prognostic issues are uncovered.

The presently disclosed system and methods overcome one or more of the problems identified above.

### BRIEF SUMMARY OF THE INVENTION

In one aspect, the present invention may be characterized as a vehicle diagnostic and prognostic system comprising a vehicle interface architecture subsystem, a vehicle configuration information subsystem, an applications engine, and a presentation subsystem. More specifically, the vehicle interface architecture subsystem is adapted for retrieving operational data and identification data from a vehicle and the vehicle configuration information subsystem is adapted for providing vehicle configuration data, vehicle variant data and/or driving style related data. Both of these subsystems are coupled to the applications engine that is adapted for analysing the data, identifying trends and making a prognosis. The vehicle diagnostic and prognostic information presentation subsystem is also coupled to the applications engine and adapted for graphical presentation of information to the repair technician or other interested parties.

In another aspect, a method of vehicle diagnostics and prognostics is provided. The disclosed method includes the basic steps of: (a) defining a plurality of data inputs and data factors to be monitored for a vehicle; (b) collecting the defined data inputs and data factors as well as a case history for the vehicle; (c) determining the weighting or influence of the data inputs and data factors; and (d) analyzing the data inputs and data factors to create the diagnostic and prognostic results. Additional steps in the disclosed method include: (e) further analyzing the data inputs and data factors to develop trend information; (f) assessing the vehicle case history to predict likely failures based on historical analysis of data inputs and data factors; and (g) preparing an overall diagnostic and prognostic output based on the diagnostic and prognostic results, trend information, and historical analysis.

These and other features, aspects and advantages of the present invention will become more apparent from consideration of the detailed description and drawings set forth below.

### BRIEF DESCRIPTION OF THE DRAWINGS

The above and other aspects, features and advantages of the present invention will be more apparent from the following more particular description thereof, presented in conjunction with the following drawings wherein:

FIG. 1 is a high-level illustration of the basic structure of the present vehicle diagnostic and prognostic system;

FIG. 2 is a schematic diagram of a preferred embodiment of the present vehicle diagnostic and prognostic system;

FIG. 3 is a schematic diagram depicting the basic operation and function of the applications engine in the preferred embodiment of the diagnostic and prognostic system; and

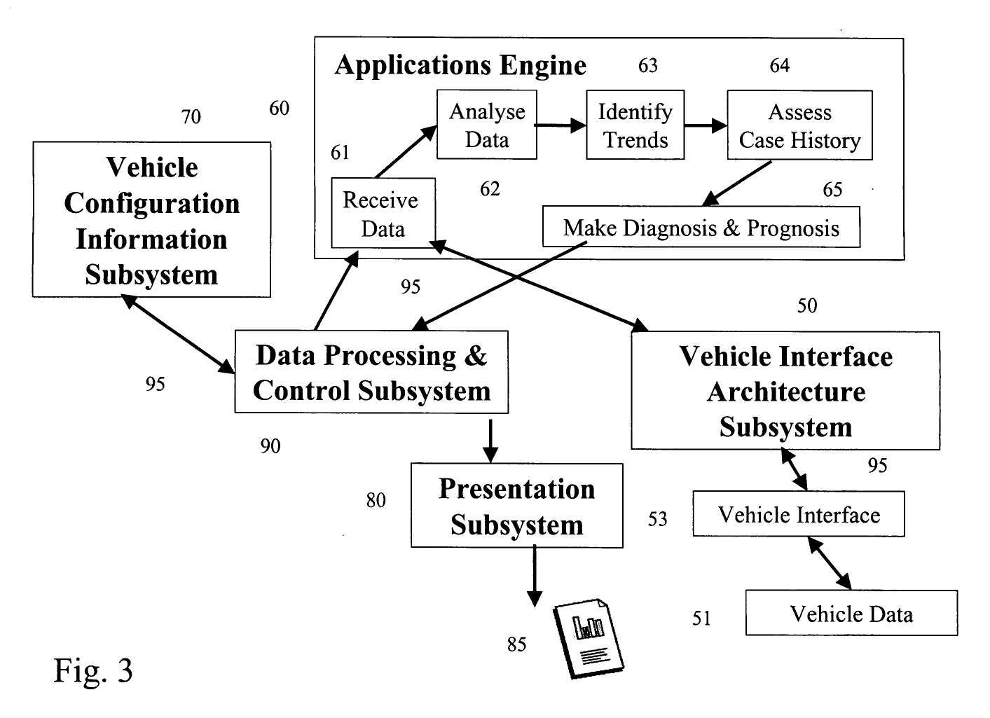

FIG. 4 is a block diagram depicting the preferred diagnostic and prognostic method associated with the present invention.

### DETAILED DESCRIPTION

The following description includes the best mode presently contemplated for carrying out the invention. This description is not to be taken in a limiting sense but is made merely for the purpose of describing the general principals of the invention. The scope and breadth of the invention should be determined with reference to the claims.

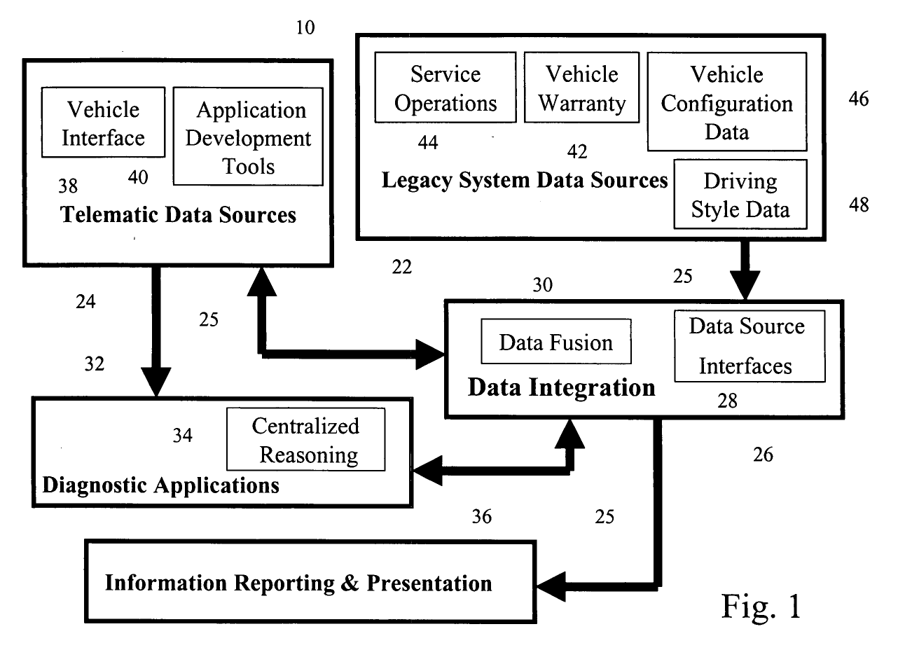

As seen in FIG. 1 a high-level illustration of the present diagnostic and prognostic system (10) is depicted. Specifically, FIG. 1 shows a collection of legacy system data sources (22) and telematic data sources (24) brought together via one or more communications networks (25) to a data integration means (26) that may include appropriate data source interfaces (28) and data fusion means (30). Once together, the information from the various data sources is utilized within selected diagnostic applications (32) that represent the centralized reasoning means (34) of the present system (10). The information, both raw and analyzed, may then be presented to users via an information reporting and presentation means (36). As seen therein, the telematic data sources (24) include a vehicle interface (38) or other means to interface with a vehicle as well as application development tools (40) useful to extract and analyze the vehicle data. The legacy system data sources (22) may include data sources such as vehicle warranty (42), service operations (44), vehicle as-built or vehicle configuration data (46), and vehicle behavioral/driving style data (48) as well as other traditional and conventional data sources.

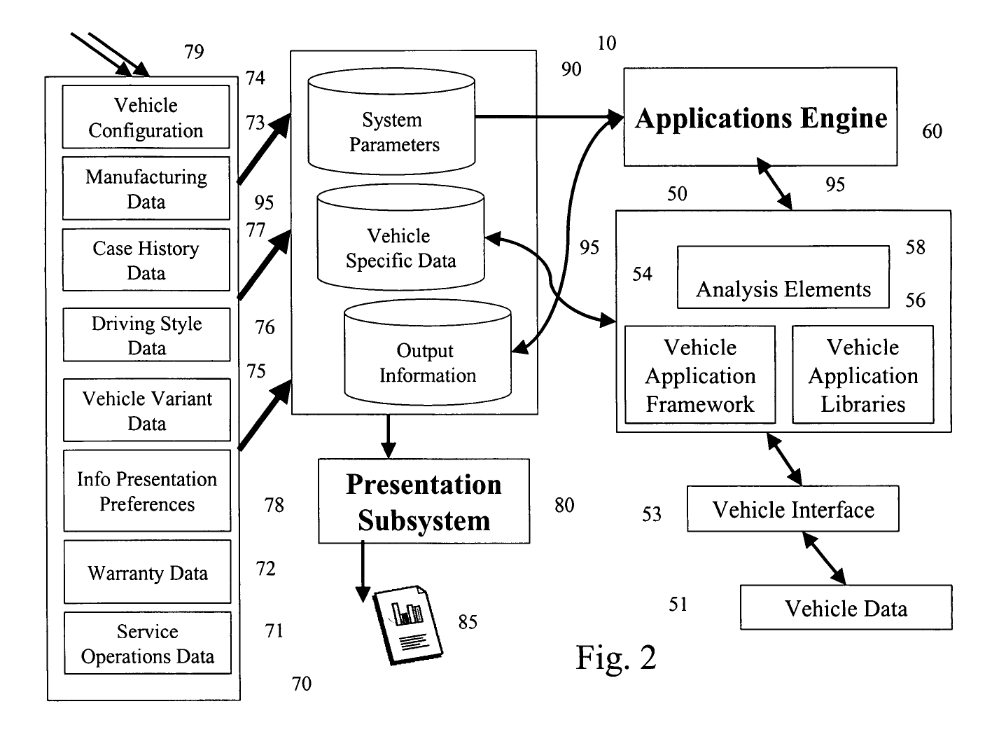

Turning now to FIG. 2, the system (10) architecture of the preferred embodiment is built around five main subsystems, namely the vehicle interface architecture subsystem (50), the applications engine (60), the vehicle configuration information subsystem (70), the vehicle information presentation subsystem (80), and the central data processing and control subsystem (90). Each of these subsystems is described in the paragraphs that follow.

Vehicle Interface Architecture Subsystem

The vehicle interface architecture subsystem (50) is a telematic based software suite or workbench that is used to create potentially very complex diagnostic and prognostic applications that interact with the electronic modules fitted to the vehicles. With reference back to FIG. 1, the vehicle interface architecture subsystem is contained within the telematic data sources (24) that interfaces with the vehicle in question and provides the prescribed data as well as the software application elements or tools used by the data fusion element (30) and centralized reasoning element (34) of the overall system (10).

Turning again to FIG. 2, the preferred interaction between the vehicle interface architecture subsystem (50) and the vehicle or vehicle data (51) may be via the vehicle interface (53) and may include a wireless environment or direct-coupled arrangement. The vehicle interface architecture subsystem (50) allows the creation and use of diagnostic and prognostic software applications that help transform raw vehicle data (51) into useful diagnostic and prognostic information.

The preferred embodiment of the vehicle interface architecture subsystem (50) is a workbench type utility system that made up of at least three main components, namely the vehicle application framework (54), vehicle application libraries (56), and the application analysis elements (58). Each of these three components are resident within a single operating system based platform or, alternatively may be resident on distinct platforms but operatively coupled by virtue of a communications network. The same communication network may also provide access to external data sources such as legacy system data sources.

The vehicle application framework (54) illustrated in FIG. 2, provides data driven software interfaces between the raw vehicle messages that are present on the multiplex buses of the vehicles and the diagnostic software applications. These data driven software interfaces provide a layer of abstraction from the specifics of vehicle bus allowing diagnostic and prognostic software that is developed for a given vehicle or application to be portable and used with different vehicles and different applications. For example the if a software developer or author desired the odometer reading for a particular vehicle as part of a diagnostic or prognostic software application they would make a generic request ‘GetOdometer( )’. The vehicle interface architecture subsystem (50), and in particular the vehicle application framework (54) would translate the generic request ‘GetOdometero’ into the specific request to the vehicle and the value of odometer for the specific vehicle would be retrieved.

The vehicle application libraries (56) include application specific information about the vehicle, its data bus information, and information useful to aid in the extraction and use of vehicle data (51) including operational and identification data. The application analysis elements (58) are part of a graphically driven integrated development environment (IDE) used for the creation of vehicle diagnostic and prognostic applications. The vehicle application libraries (56) and application analysis elements (58) are logically sequenced within the IDE to allow the creation of more complex and interactive diagnostic and prognostic applications. The application analysis elements (58) include the software applications as well as graphical editors, variant management tools, direct visualization of sequences, simulation and debug tools all which facilitates the rapid design, development and deployment of diagnostic and prognostic applications or other telematic based software applications.

In the presently described embodiment, the vehicle applications libraries (56) that are part of the vehicle interface architecture subsystem (50) are controlled by a data description of the vehicle stored in a database. The database provides a repository for vehicle-specific information including information about the specific data bus for that vehicle. The information is typically gathered from vehicle manufacturers and may include proprietary data bus configurations for each vehicle make and model potentially served by the diagnostic and prognostic application. The database may be local or remote to the vehicle applications libraries (56) and may also be restricted to provide access to only a subset of information about the vehicle based on the privileges of the requestor or other prescribed conditions associated with the on-going diagnostic or prognostic applications. In the preferred embodiment, the vehicle applications libraries (56) are configured from the database either at start up or on-demand during runtime of the diagnostic/prognostic application. In practice, a programmer or other software developer can take advantage of the vehicle applications libraries (56) to simplify the application at a high level such that data requests may be made generically, or independent of the vehicle make or model.

Vehicle Configuration Information Subsystem

The use of electronic modules and communication networks in vehicles has significantly grown in the past decade. While such increased use of electronic modules and communication networks has lead to improvement in vehicle reliability and quality, the number of potential electronic faults on a typical vehicle has also significantly increased. Because of the increase in use of programmable electronic modules and communication equipment within vehicles, potentially every vehicle a manufacturer builds may be different, both in physical construction, how the electronic modules are programmed, and how data is communicated within the vehicle as well as communication to external sources. The various manufacturers typically have proprietary as-built configuration databases and as-maintained databases for every vehicle they produce, in part to manage the variant complexity introduced by software programmability.

The present embodiment of the vehicle configuration information subsystem (70) includes appropriate interfaces or replicated versions of such external databases or data sources. Such external databases or data sources may include service operations data (71), warranty system data (72), manufacturer design data (including reliability, maintainability and quality data) (73), vehicle configuration data (74), vehicle variant data (75), vehicle behaviora/driving style data (76), vehicle maintenance history data (77) and other conventional data sources. These data sources may be dispersed at various remote locations or centralized at one or more locations depending on the preference of the data owners. In addition, the vehicle configuration information subsystem (70) may include customized report formats and information presentation preferences (78) for different vehicle types and users. The techniques for establishing interfaces (79) between the external data sources and the vehicle configuration information subsystem (70) within a given communication network is through the authorized use of common enabling communication and software technologies such as web-based services or various client-server applications which are generally known to those skilled in the art.

Applications Engine

The applications engine (60) is the centralized reasoning element (34) of the system (10). Broadly speaking, the applications engine (60) provides five basic functions, namely: to receive data to be analyzed from the appropriate data sources (61); analyze the data (62); identify trends (63); consider the case history of the vehicle in question (64); and make the appropriate diagnosis and prognosis (65). These functions are preferably executed using previously developed or on-demand diagnostic software routines created for or resident within a single operating system based platform or controller.

More specifically, the preferred embodiment of the applications engine (60) is a plurality of executable software modules or applications that are adapted to receive data from various data sources, including external data sources, associated with the vehicle configuration information subsystem (70) as well as vehicle data (51) via the vehicle interface (53) and the vehicle interface architecture subsystem (50). Preferably, the data used by the software modules within the applications engine (60) will include behavioral/driving style related information as well as other real-time vehicle data and historical vehicle data.

After the data retrieval step, the applications engine (60) proceeds to analyze the retrieved data according to prescribed analysis techniques constructed or commanded by the vehicle interface architecture subsystem (50). In addition, the applications engine may also identify any trends found in the data or analyzed information. The applications engine (60) may be further adapted to consider the case history of the vehicle under assessment from an external data source such as the manufacturer or service operational center. Using the data analysis, trends, and case history as well as other vehicle configuration data, the applications engine (60) proceeds to make a diagnosis or prognosis and forward such output information to the data processing and control subsystem (90) to be presented via presentation subsystem (80).

Vehicle Prognostic Information Presentation Subsystem

The vehicle prognostic information presentation subsystem (80) provides information output by the programmed applications and useful to the service technician, service organization and/or the vehicle manufacturer. Because the present vehicle diagnostic and prognostic system (10) is premised on the flexibility and rapid deployment of prognostic and diagnostic applications, there is no need for set reports or graphs, as the software developer can customize the reports or presentation of data and information depending on the prognostic and diagnostic applications being developed. Examples of the preferred prognostic and diagnostic reports (85) would include probable fault candidates ranked by likelihood of failure, pre-failure environment information for fault candidates, confirmation of fault candidates, predictive service schedules, component life predictions, adjusted reliability and maintainability factors, and recommended component replacements. Preferably, the presentation subsystem (80) will include or have access to customized report formats and information presentation preferences (78) for different vehicle types and users from the vehicle configuration information subsystem (70).

Data Processing and Control Subsystem

The data processing and control subsystem (90) is the basis for performing data integration functions including data fusion and as well as establishing interfaces with the legacy system data sources as well as the telematic data sources. Specifically, the data processing and control subsystem (90) is coupled to the vehicle interface architecture subsystem (50), the vehicle configuration information subsystem (70), the presentation subsystem (80), as well as the applications engine (60) via one or more communication networks (95).

The data processing and control subsystem (90) is the primary means for achieving the integration and fusion of the various data sources. The relevant data from the various data systems are stored, indexed or otherwise made available in a unified manner within the data processing and control subsystem (90) for use by users of the vehicle prognostics system (10). Such uses include processing of system parameters for specific software applications executed by the applications engine (60) or processing of vehicle specific data and/or system parameters for newly created software applications created on-demand through the vehicle interface architecture subsystem (50). In addition, the data processing and control subsystem (90) can receive output information from the applications engine and provide the output information or direct access of other vehicle data to users of the presentation subsystem (80). Finally, the data processing and control subsystem (90) can also be used to update and or validate the various data sources within the vehicle configuration information subsystem (70) as required.

Examples of the benefits of such data integration or data fusion of the data processing and control subsystem (90) may include analysis of driving style related data to help predict the mean time to failure (MTTF) or other reliability and maintainability factors of various vehicle components and systems. By capturing the driving and journey style, it is possible to create a more dynamic vehicle service model and generate dynamic reliability and maintainability factors for many vehicle components and systems. Fusing driving style and other behavioural or real time data with failure prediction information, it is possible to predict optimum time for component replacement beyond fixed scheduled maintenance period. Also, pre-failure environmental information can be used to provide additional weighting or influence to component failure candidates within service bay.

Similarly, fusion of vehicle engineering and as-built configuration data with real-time vehicle operational data allows both the service technician or service organization as well as the manufacturer to observe relationships and trends with the vehicle(s) in question that are not otherwise apparent. The benefit of such data fusion would include enhanced vehicle knowledge through the fusion of vehicle data with other legacy system data sources. This enhanced vehicle knowledge, occurring in a real-time or near real time environment gives the vehicle manufacturer opportunities to enhance their business processes for commercial success as well as increase end-user satisfaction

Detailed Prognostic Engine Methodology

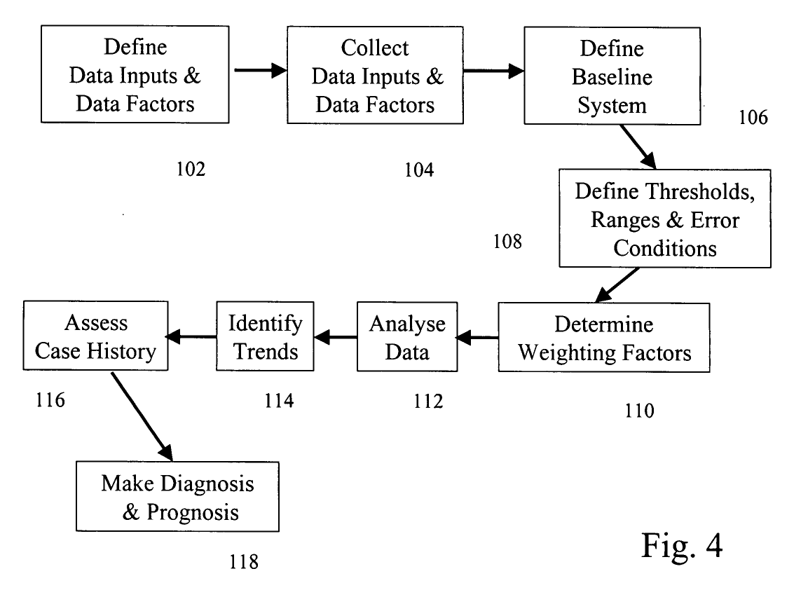

Turning now to FIG. 4, the generic phases of the preferred diagnostic and prognostic methodology are depicted. The exact order, sequence, and execution of the steps or phases may be interchanged or some of the phases even skipped altogether, depending on the identified prognostic or diagnostic application being executed.

Phase 1—Collect Data. Steps performed during this phase include defining the data inputs, data factors and system parameters (Block 102) to be used or monitored as part of the vehicle prognostics as well as collecting the defined data inputs, data factors and system parameters (Block 104). The data inputs, data factors and system parameters generally include vehicle identification data, vehicle operational data, vehicle driving style data, vehicle configuration and engineering data, vehicle variant data, warranty data, and service operations data. In addition, information as to what analysis techniques to use, what trends to look for, what format to output the analysis can also be included.

Phase 2—Analyze Data. Steps performed during this phase include defining a baseline system (Block 106) upon which the selected real-time data or data factors are to be compared as well as defining any thresholds, permissible ranges or error conditions associated with such data factors (Block 108). In addition, the applications engine also determines the weighting or influence of selected data factors on the overall diagnostic and prognostic results (Block 110). Factors may include such items as type and length of typical journey, environmental conditions, and driver style. The preferred method then performs the basic diagnostic and prognostic analysis (Block 112) specified for the vehicle in question based on the system parameters, data factors and data inputs received.

Phase 3—Perform Trend Analysis. During this phase, the method involves performing selected analysis to develop trend information related to the particular vehicle or configuration using the data collected from various sources (Block 114).

Phase 4—Perform Case History Analysis. During this phase, the preferred vehicle diagnostic and prognostic method uses vehicle or configuration case histories as well as related vehicle knowledge to develop or predict likely vehicle failures based on historical analysis of data associated with the vehicle (Block 116).

Phase 5—Make Vehicle Diagnosis and Prognosis. This phase of the preferred method takes the results of the analysis performed in the basic analysis, trending analysis and case history analysis steps and makes an overall diagnosis or prognosis of the vehicle or configuration under assessment (Block 118). The output information may typically include probable fault candidates ranked by likelihood of occurrence and pre-failure environment information which is used to repair the vehicle in question or can be used for predictive service scheduling, failure mode and effects analysis, component life predictions, and other reliability, maintainability and quality assessments.

From the foregoing, it can be seen that the disclosed invention is a system and method for vehicle diagnostics prognostics that employs a flexible, on-demand application development architecture with both legacy data sources and real-time vehicle data. While the invention herein disclosed has been described by means of specific embodiments and processes associated therewith, numerous modifications and variations could be made thereto by those skilled in the art without departing from the scope of the invention as set forth in the claims.

What is claimed is:

1. A vehicle diagnostic and prognostic system comprising:
a vehicle interface architecture subsystem adapted for interfacing with a vehicle to collect a first subset of data from a vehicle;
a vehicle configuration information subsystem adapted for providing a second set of data about said vehicle from a plurality of external data sources;
an applications engine in operative communication with the vehicle interface architecture subsystem and the vehicle configuration information subsystem, the applications engine adapted for analysing said first subset of data together with the second subset of data and preparing an output information; and
a presentation subsystem operatively coupled to the applications engine and adapted for presentation of said output information.

2. The vehicle diagnostic and prognostic system of claim 1 wherein said output information includes failure analysis information and trend analysis information for said vehicle

3. The vehicle diagnostic and prognostic system of claim 1 wherein said output information includes failure analysis information and case history analysis information for said vehicle.

4. The vehicle diagnostic and prognostic system of claim 1 wherein said vehicle interface architecture subsystem further comprises a plurality of data driven software interfaces between the first subset of data and one or more diagnostic software applications.

5. The vehicle diagnostic and prognostic system of claim 1 wherein said vehicle interface architecture subsystem further comprises vehicle application libraries that contain specific information about said vehicle.

6. The vehicle diagnostic and prognostic system of claim 1 wherein said vehicle interface architecture subsystem further comprises application analysis elements adapted for creation of diagnostic and prognostic software applications.

7. The vehicle diagnostic and prognostic system of claim 1 wherein said second set of data further comprises vehicle configuration data.

8. The vehicle diagnostic and prognostic system of claim 1 wherein said second set of data further comprises driving style data.

9. The vehicle diagnostic and prognostic system of claim 1 wherein said second set of data further comprises vehicle case history data.

10. A method of vehicle diagnostics and prognostics comprising the steps of:
defining a plurality of data inputs and data factors to be monitored for a vehicle;
collecting the defined data inputs and data factors and a case history for said vehicle;
determining the weighting factors of said data inputs and data factors on a set of diagnostic and prognostic results;
analyzing the data inputs and data factors based on said weighting factors to create the initial set of diagnostic and prognostic results;
further analyzing the data inputs and data factors to develop trend information related to the vehicle using the data inputs and data factors;
assessing the vehicle case history to predict likely failures based on historical analysis of data inputs and data factors; and
preparing an overall diagnostic and prognostic output based on said initial set of diagnostic and prognostic results, trend information, and historical analysis.

11. The method of claim 10 wherein the data inputs and data factors include are selected from the group consisting of vehicle identification and operational data; driving style data; vehicle configuration and variant data; vehicle warranty data, and service operations data.

12. The method of claim 11 further comprising the step of defining a vehicle baseline upon which the collected data inputs and data factors shall be compared, said baseline further including one or more of defined thresholds, permissible ranges, or error conditions associated with such data inputs and data factors.

13. A vehicle diagnostic and prognostic system comprising:
a data processing and control subsystem;
a vehicle interface architecture subsystem adapted for retrieving operational data and identification data from vehicles and further adapted for developing diagnostic and prognostic software applications for said vehicles.
a vehicle configuration information subsystem in operative communication with the data processing and control subsystem, the vehicle configuration information subsystem adapted for providing vehicle configuration data and driving style data to the data processing and control subsystem;
an applications engine in operative communication with the vehicle interface architecture subsystem and the data processing and control subsystem, the applications engine adapted for analysing data from vehicles and the vehicle configuration information subsystem using diagnostic and prognostic software applications for said vehicles and preparing output information;
an information presentation subsystem operatively coupled to the applications engine and the data processing and control subsystem and adapted for presentation of said output information.
